(19) United States
(12) Patent Application Publication
(10) Pub. No.: US 2012/0331175 A1
(43) Pub. Date: Dec. 27, 2012

(54) IMAGE PROCESSING APPARATUS THAT COMMUNICATES WITH SERVER VIA RELAY DEVICE, METHOD OF CONTROLLING IMAGE PROCESSING APPARATUS, AND STORAGE MEDIUM

(75) Inventor: Fumitoshi Ito, Kawasaki-shi (JP)

(73) Assignee: CANON KABUSHIKI KAISHA, Tokyo (JP)

(21) Appl. No.: 13/533,397

(22) Filed: Jun. 26, 2012

(30) Foreign Application Priority Data
Jun. 27, 2011 (JP) 2011-141718

(51) Int. Cl. G06F 15/16

(52) U.S. Cl. 709/246

(57) ABSTRACT

An image processing apparatus having a web browser capable of appropriately operating according to an instruction from a web server in a reverse proxy-type SSO system. The image processing apparatus communicates with the web server via a reverse proxy server. When a script containing a URL is received from the web server via the reverse proxy server, the image processing apparatus acquires a URL conversion table for converting the URL contained in the script to another URL, from the reverse proxy server. The image processing apparatus rewrites the URL contained in the script received from the web server, based on the URL conversion table.

### BACKGROUND OF THE INVENTION

1. Field of the Invention

The present invention relates to an image processing apparatus, a method of controlling the same, and a storage medium, and more particularly to an image processing apparatus which is capable of displaying an operation screen provided by a web server, using a web browser, a method of controlling the image processing apparatus, and a storage medium.

2. Description of the Related Art

There has been known a service in which an information processing apparatus, such as a personal computer (PC), is connected to a web server on a network, and an operation screen provided by the web server is displayed on a web browser of the information processing apparatus. In this case, first, the web browser of the information processing apparatus requests the web server to send an operation screen. A web application on the web server sends an HTML file for causing the web browser to display the operation screen to the information processing apparatus in response to the request from the information processing apparatus. The web browser of the information processing apparatus analyzes the received HTML file and displays the operation screen based on the description of the HTML file.

When a user inputs instruction information via the operation screen displayed on the web browser, the web browser sends the input instruction information to the web server. When the web server receives this instruction information, the web application on the web server executes processing according to the input instruction information.

By the way, recently, some of recent MFPs (multi-function peripherals) equipped with a scanner function and a printer function are provided with a web browser of the above-mentioned type. In the MFPs of this type as well, an operation screen provided by a web server is displayed on the web browser of the MFP, following the above-mentioned procedure, whereby various instructions are received from a user.

Japanese Patent Laid-Open Publication No. 2006-127503 discloses a technique described below. First, when a user inputs instruction information to an MFP via an operation screen displayed on the web browser of the MFP, the web browser sends the input instruction information to the web server. The web server having received this instruction information requests the MFP to execute associated processes according to the instruction information input by the user. The MFP having received the request executes the requested processes. This not only eliminates the need to store all menu data for operating the MFP in the MFP, but also facilitates changing the menu data on the web server.

Further, Japanese Patent Laid-Open Publication No. 2005-321970 has disclosed an SSO (single sign-on) system in which once a user has been authenticated in a system using a web server and a web browser, the user is permitted to use all functions associated with the authentication. The SSO system includes a type in which an SSO server is provided for permitting access to the web server only through the SSO server. This type is called the reverse proxy type, because the SSO server plays the role of a proxy server for the web server. The IceWall (registered trademark) SSO system of HP Japan can be mentioned as an example for the reverse proxy type.

In the case of the reverse proxy-type SSO system, it looks to the web browser as if all contents exist in the reverse proxy. For this reason, in the reverse proxy, when a link or the like is set in a content, a change occurs in the URL of a link destination, and therefore it is required to rewrite the content according to the change. Contents which need rewriting include, for example, an HTML content, a stylesheet content, a content in a script language, and a content of Java (registered trademark) Script which operates on a web browser.

Requests sent from a web server to an MFP for execution of various processes sometimes include a request for transmitting a scanned image using the HTTP protocol. In this case, since the MFP performs communication using the HTTP protocol, it is required to access a reverse proxy. However, the web server cannot recognize intervention of the reverse proxy from information contained in the request from the web browser. Further, the web server cannot grasp how URL conversion is performed by the reverse proxy, either. For this reason, similarly to the above-mentioned case of contents, the reverse proxy is required to rewrite an HTTP destination URL address contained in the request received from the web server, for execution of transmission.

However, the data format of a request to be issued from the web server to the MFP process, for execution of a process is not predetermined, and hence it is beyond the capability of the reverse proxy to rewrite contents into any format in use. Further, if the configuration of a reverse proxy has to be changed whenever the data format is changed, it is troublesome. Thus, it is difficult to cause the above-described system using a web server and an MFP to join the reverse proxy-type SSO system.

### SUMMARY OF THE INVENTION

The present invention provides an image processing apparatus having a web browser capable of appropriately operating in response to an instruction from a web server in a reverse proxy-type SSO system.

In a first aspect of the present invention, there is provided an image processing apparatus that communicates with a server via a relay apparatus, comprising an acquisition unit configured to be operable when a script containing a URL is received from the server via the relay apparatus, to acquire conversion information for converting the URL contained in the script to another URL, from the relay apparatus, and a rewriting unit configured to rewrite the URL contained in the script received from the server, based on the conversion information.

In a second aspect of the present invention, there is provided a method of controlling an image processing apparatus that communicates with a server via a relay apparatus, comprising receiving a script containing a URL from the server via the relay apparatus, acquiring conversion information for converting the URL contained in the received script to another URL, from the relay apparatus, and rewriting the URL contained in the script received from the server, based on the acquired conversion information.

In a third aspect of the present invention, there is provided a non-transitory computer-readable storage medium storing a computer-executable program for causing a computer to execute a method of controlling an image processing apparatus that communicates with a server via a relay apparatus, wherein the method comprises receiving a script containing a URL from the server via the relay apparatus, acquiring conversion information for converting the URL contained in the received script to another URL, from the relay apparatus, and rewriting the URL contained in the script received from the server, based on the acquired conversion information.

According to the present invention, it is possible to execute an instruction from the web server in the image processing apparatus in the reverse proxy-type SSO system without special URL conversion by the reverse proxy.

Further features of the present invention will become apparent from the following description of exemplary embodiments with reference to the attached drawings.

### BRIEF DESCRIPTION OF THE DRAWINGS

FIG. 1 is a diagram showing the general configuration of an image processing system including an image processing apparatus (MFP) according to a first embodiment of the present invention.

FIG. 2 is a schematic block diagram of the hardware configuration of the MFP appearing in FIG. 1.

FIG. 3 is a block diagram of the hardware configuration of a reverse proxy server appearing in FIG. 1.

FIG. 4 is a schematic block diagram of the software configuration of the MFP.

FIG. 5 is a schematic block diagram of the software configuration of the reverse proxy server.

FIG. 6 is a diagram of an example of a URL conversion table used by the image processing apparatus according to the first embodiment.

FIG. 7 is a schematic block diagram of the software configuration of a web server appearing in FIG. 1.

FIG. 8 is a sequence diagram of a scan and transmission process executed in the image processing system in FIG. 1.

FIG. 9 is a view of an example of a configuration screen displayed by a web browser in a step in FIG. 8.

FIG. 10 is a view of an example of script data used by the image processing apparatus according to the first embodiment.

FIG. 11 is a flowchart of a script execution process executed by a script execution section of the image processing apparatus according to the first embodiment.

FIG. 12 is a view of an example of script data used by an image processing apparatus according to a second embodiment of the present invention.

FIG. 13 is a flowchart of a script execution process executed by a script execution section of the image processing apparatus according to the second embodiment.

FIG. 14 is a diagram of an example of a URL conversion table used by the image processing apparatus according to the second embodiment.

### DESCRIPTION OF THE EMBODIMENTS

The present invention will now be described in detail below with reference to the accompanying drawings showing embodiments thereof.

First, a description will be given of a first embodiment of the present invention.

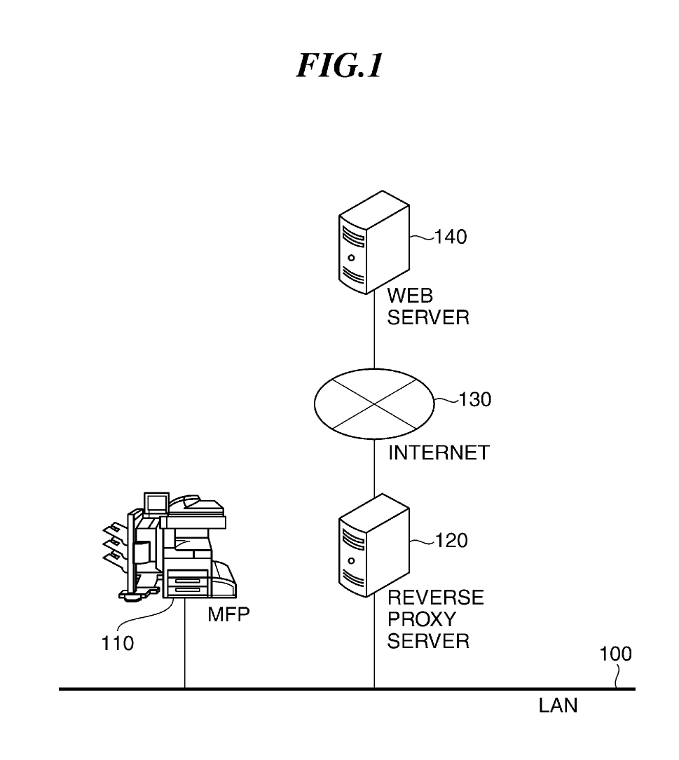

FIG. 1 is a diagram showing the general configuration of an image processing system including an image processing apparatus according to the first embodiment of the present invention. Note that the number of apparatuses constituting the image processing system is not limited to the number of apparatuses in FIG. 1.

Referring to FIG. 1, an MFP 110 is an image processing apparatus equipped with a copy function and a data transmission function for transmitting image data acquired by reading an original image to an apparatus connected to a network, using the HTTP protocol, the WebDAV protocol, or like other protocols. The MFP 110 is connected to a LAN 100 implemented e.g. by the Ethernet (registered trademark), and can be connected to the Internet 130 via a reverse proxy server 120 on the LAN 100. A web server 140 is provided on the Internet 130.

The reverse proxy server 120 (second server) relays transmission of a request from the MFP 110 to the web server 140 and a response to the request.

The web server 140 (first server) transmits an HTML page to be displayed on the MFP 110, as a response to a request from the MFP 110, using a web application. Further, the web server 140 transmits an image processing instruction as a response to a request from the MFP 110.

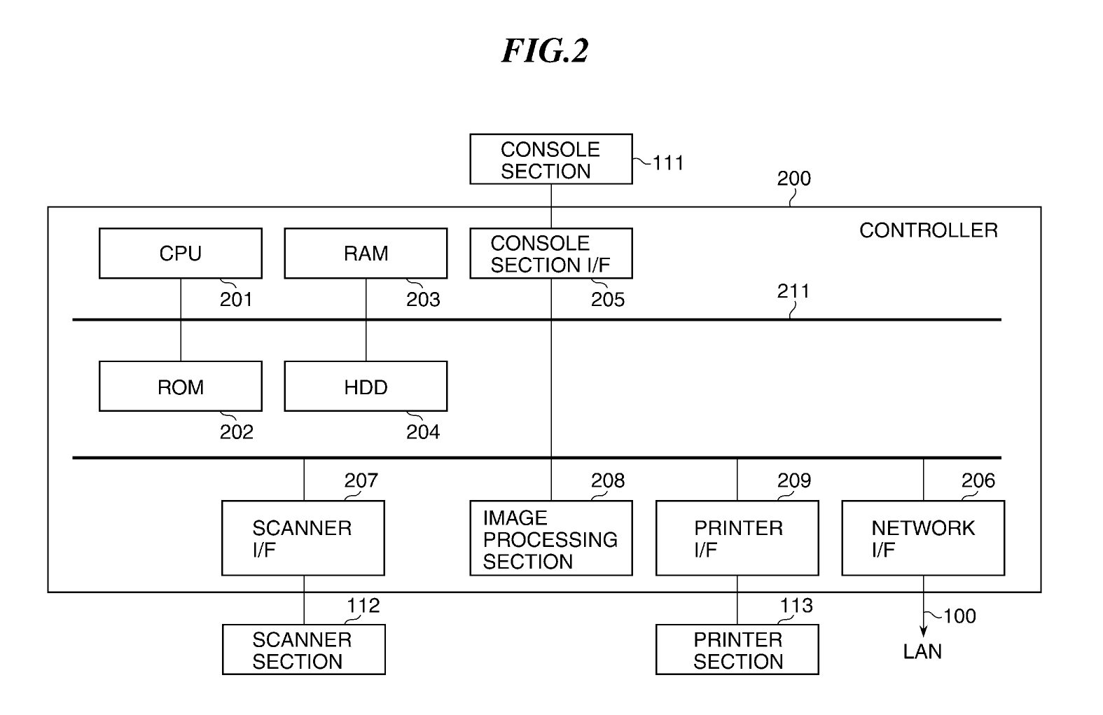

FIG. 2 is a schematic block diagram of the hardware configuration of the MFP 110 appearing in FIG. 1.

Referring to FIG. 2, the MFP 110 comprises a scanner section 112 as an image input device, a printer section 113 as an image output device, a controller 200 that controls the overall operation of the MFP 110, and a console section 111. The scanner section 112 reads an image from an original placed thereon and generates image data. The printer section 113 forms an image on a sheet as a print image based on image data received from the controller 200.

The controller 200 is not only electrically connected to the console section 111, the scanner section 112, and the printer section 113, but also connected to the LAN 100 via a network interface 206. In other words, the controller 200 is connected to external apparatuses via the LAN 100. This enables the controller 200 to perform communication using the HTTP protocol.

The controller 200 comprises the following component elements as shown in FIG. 2. A CPU 201 performs centralized control of access to the MFP 110 and access from the external apparatuses based on control programs and the like stored in a ROM 202. Further, the CPU 201 also performs centralized control of various kinds of processing performed within the controller 200. This control includes execution of a program for realizing a script execution process described hereinafter.

The ROM 202 stores a boot program for the apparatus. A RAM 203 is a system work memory which the CPU 201 uses to operate, and at the same time, a memory for temporarily storing image data. Further, the RAM 203 comprises an area in which data stored therein is preserved e.g. by back-up power supply even after the power of the apparatus is switched off, and an area in which data stored therein is deleted after the power is switched off.

An HDD 204 is a large-capacity storage device which is capable of storing system software and image data. A console section interface 205 connects between a system bus 211 and the console section 111. The console section interface 205 receives image data to be displayed on the console section 111 from the system bus 211 and outputs the same to the console section 111. The console section interface 205 also receives information input from the console section 111 and outputs the same to the system bus 211. The network interface 206 connects between the LAN 100 and the system bus 211, and performs inputting and outputting of information.

A scanner interface 207 performs correction, processing, and editing of image data received from the scanner section 112. Note that the scanner interface 207 has a function of determining whether the received image data is of a color original or of a monochrome original, whether it is of a text original or of a picture original, etc.

An image processing section 208 performs turning, compression, expansion, or the like of image data. Further, the image processing section 208 is capable of combining images stored in the HDD 204 into one image.

A printer interface 209 receives image data transmitted from the image processing section 208, and performs image formation based on the image data while referring to attribute data attached to the image data. The image data having been subjected to the image formation is output to the printer section 113.

In the present embodiment, the MFP 110 is a network MFP that performs UI display. However, the MFP 110 may be e.g. a general-purpose computer having a general-purpose scanner, a general-purpose printer, etc. connected thereto, or an image processing apparatus of another type.

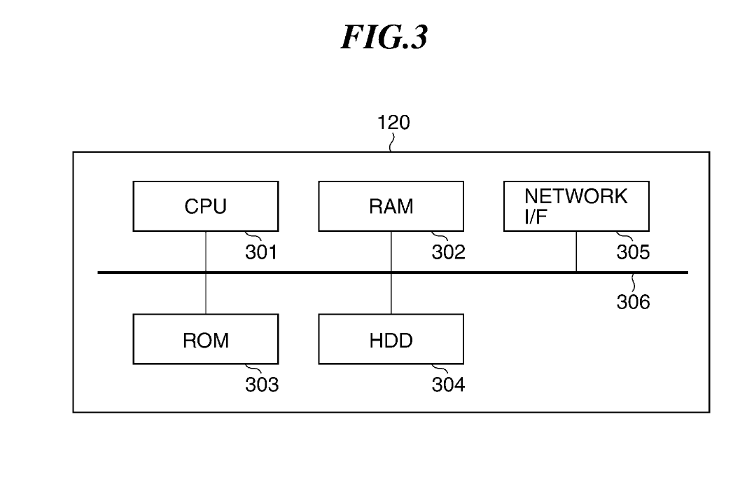

FIG. 3 is a block diagram of the hardware configuration of the reverse proxy server 120 appearing in FIG. 1.

Referring to FIG. 3, the reverse proxy server 120 comprises a CPU 301, a RAM 302, a ROM 303, a hard disk drive (HDD) 304, and a network interface 305, which are communicably interconnected via a system bus 306.

The ROM 303 or the HDD 304 stores control programs, such as an operating system (OS) and applications. The CPU 301 exerts computer functions by reading control programs from the ROM 303 or the HDD 304 into the RAM 302, as required, and executing the same. Further, the CPU 301 communicates with external apparatuses on the network connected to the reverse proxy server 120 via the network interface 305.

Note that the web server 140 has the same hardware configuration as the reverse proxy server 120 shown in FIG. 3.

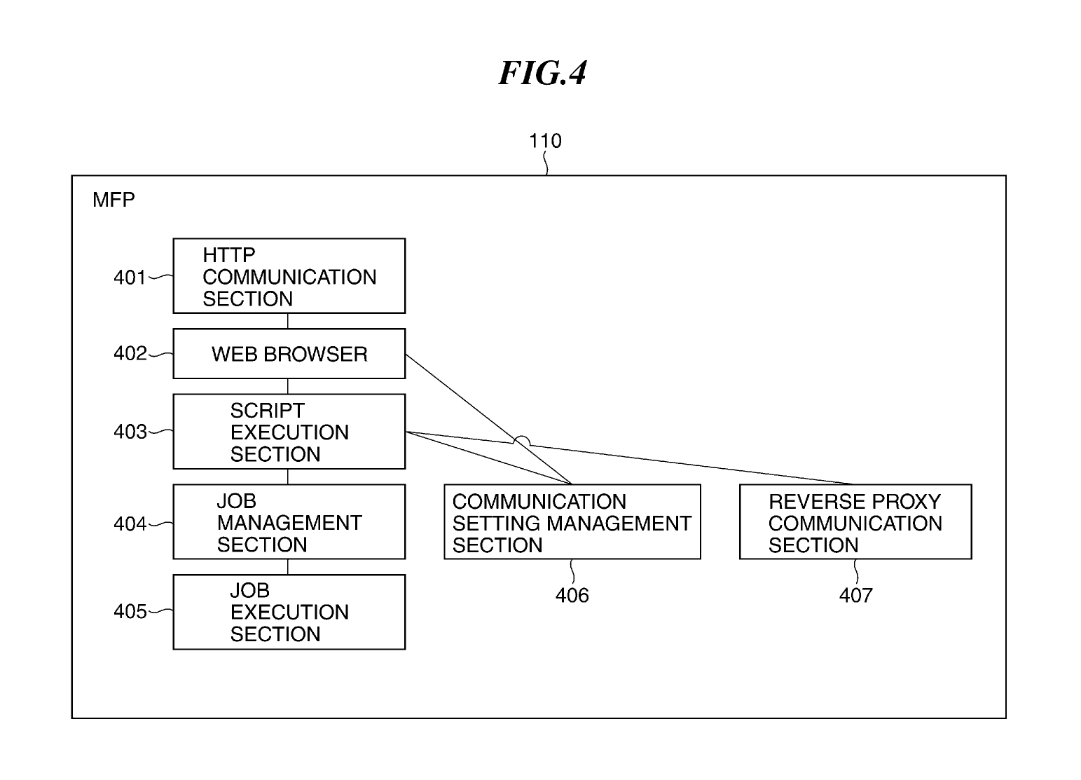

FIG. 4 is a schematic block diagram of the software configuration of the MFP 110. Software modules shown in FIG. 4 are stored in the HDD 204 of the MFP 110 and are executed by the CPU 201.

In FIG. 4, an HTTP communication section 401 is a module that performs communication using the HTTP protocol by operating the network interface 206.

A web browser 402 communicates with apparatuses on the network including the LAN 100 and the Internet 130 via the HTTP communication section 401. The web browser 402 requests a web application associated with a designated URL to send an operation screen described in HTML. Further, the web browser 402 causes HTML data of the operation screen contained in a response received via the HTTP communication section 401 to be subjected to rendering and displays the operation screen on the console section 111. Furthermore, the web browser 402 transmits data input to the operation screen displayed on the console section 111, as a request.

A script execution section 403 analyzes script data received from the web browser 402 and divides the script data on a job basis. Then, the script execution section 403 instructs a job management section 404 to execute jobs in an order specified by the script data.

The job management section 404 manages the jobs in response to the instruction received from the script execution section 403 and instructs a job execution section 405 to sequentially execute the jobs.

The job execution section 405 is a module that executes a process according to settings of a job. For example, when a designated job is a scan job, the job execution section 405 controls the scanner section 112 to read a sheet original and store image data in the HDD 204. On the other hand, when a designated job is a transmission job, the job execution section 405 controls the network interface 206 to transmit image data stored in the HDD 204.

A communication setting management section 406 is a module that manages settings for network communication by the MFP 110. Further, the communication setting management section 406 stores IP address settings and settings as to whether or not to use a reverse proxy.

A reverse proxy communication section 407 communicates with the reverse proxy server 120 to acquire the settings of the reverse proxy or to configure the settings of the reverse proxy.

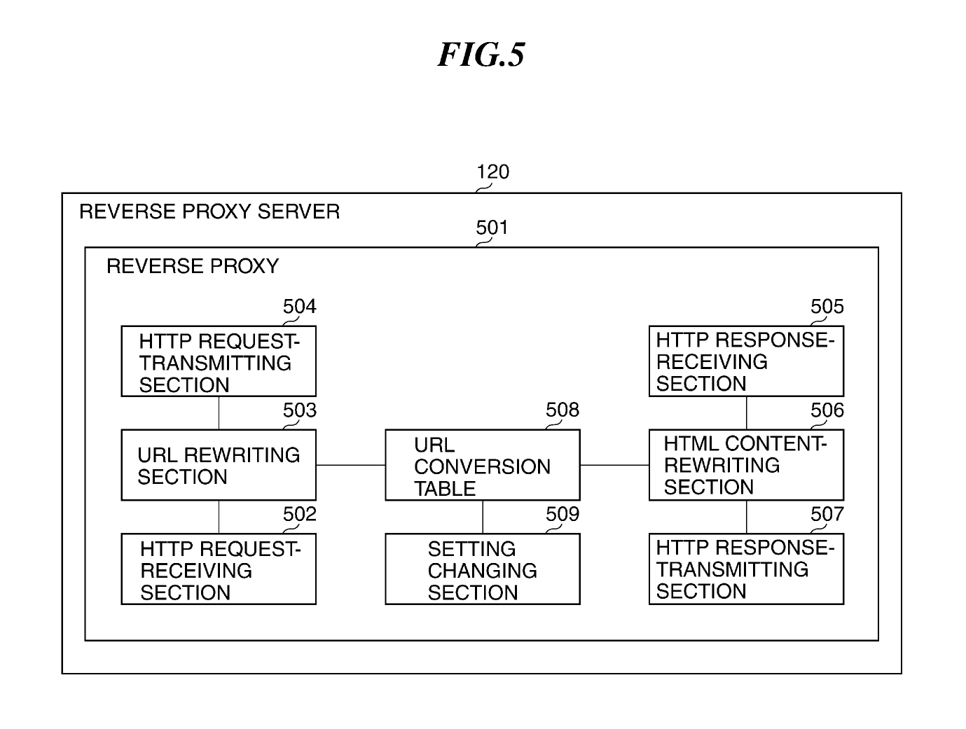

FIG. 5 is a schematic block diagram of the software configuration of the reverse proxy server 120. Software modules illustrated in FIG. 5 are stored in the HDD 304 of the reverse proxy server 120. The software modules are loaded in the RAM 302 and are executed by the CPU 301.

Referring to FIG. 5, the reverse proxy 501 is an application that operates on the reverse proxy server 120. The reverse proxy 501 includes modules described below.

An HTTP request-receiving section 502 is a module that receives an HTTP request packet sent via the LAN 100. A URL rewriting section 503 is a module that operates as a rewriting unit to rewrite a URL contained in the HTTP request packet into the URL of a transmission destination originally designated for transmission of the packet, based on settings of a URL conversion table 508. An HTTP request-transmitting section 504 is a module that transmits an HTTP request via the Internet 130 based on a URL rewritten by the URL rewriting section 503.

An HTTP response-receiving section 505 is a module that receives an HTTP response as a response to an HTTP request transmitted by the HTTP request-transmitting section 504, via the Internet 130. An HTML content-rewriting section 506 is a module that changes a URL in a content of an HTTP response received by the HTTP response-receiving section 505, based on the settings of the URL conversion table 508.

An HTTP response-transmitting section 507 is a module that transmits an HTTP response rewritten by the HTML content-rewriting section 506 to a transmission source from which the HTTP request-receiving section 502 received an associated original request. The URL conversion table 508 as URL address conversion information is a configuration table storing settings for URL conversion in the reverse proxy 501. The settings for URL conversion will be described hereinafter.

A setting changing section 509 is an interface module for changing the URL conversion table 508. Note that the setting changing section 509 may have any configuration insofar as the settings of the URL conversion table 508 can be changed by an external apparatus. In the present embodiment, the setting changing section 509 functions as a web application or a web service for receiving a setting change request from an external apparatus connected to the reverse proxy server 120 via the LAN 100.

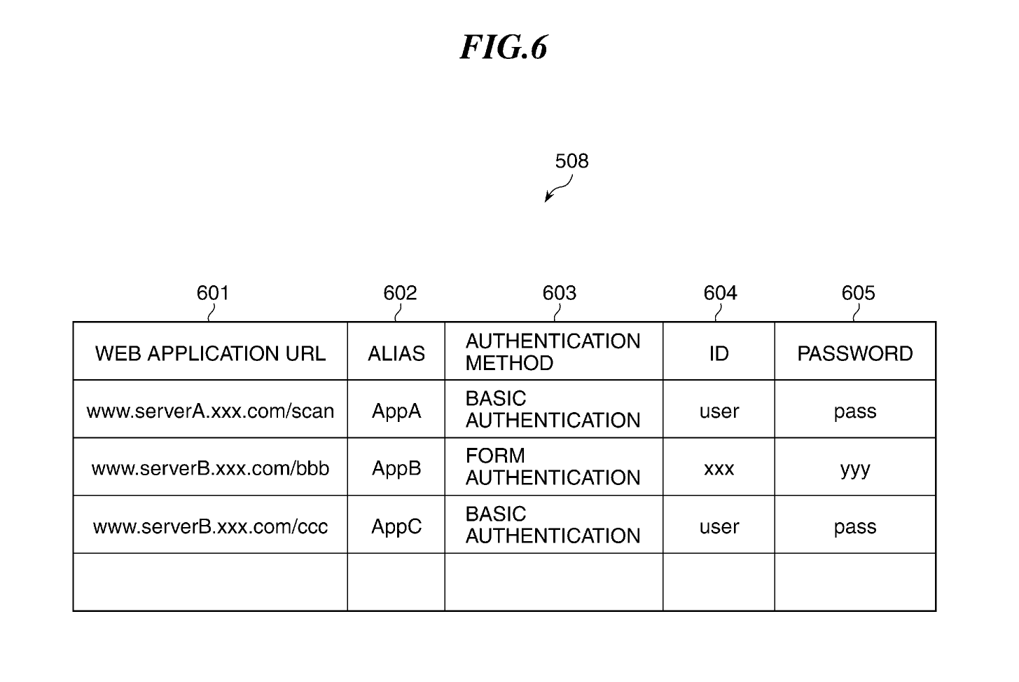

FIG. 6 is a diagram of an example of the URL conversion table 508.

Referring to FIG. 6, the URL conversion table 508 comprises a column of boxes each for entry of a web application URL, a column of boxes each for entry of an alias, a column of boxes each for entry of an authentication method, a column of boxes each for entry of an ID, and a column of boxes each for entry of a password, for example. Each box of web application URL 601 stores URL information on an associated web application on the Internet 130. Each box of alias 602 stores alias information to be used by the reverse proxy 501 in accepting connection from an apparatus connected to the LAN 100.

Each box of authentication method 603 stores an authentication method to be executed for establishing a connection to a web application indicated by URL information in an associated box of web application URL 601. Each box of ID 604 and an associated box of password 605 store an ID and a password, respectively, which are to be used in an authentication method specified in an associated box of authentication method 603.

In the example illustrated in FIG. 6, it is assumed that an HTTP request is issued from the web browser 402 of the MFP 110 to the revere proxy server 120 using the following URL:

http://<reverse proxy>/AppA/index/index.html

Note that <reverse proxy> represents the domain of the reverse proxy server.

In this case, the reverse proxy 501 issues the request to the following URL corresponding to an alias “AppA”:

http//www.serverA.xxx.com/scan/index/index.html

When making the request, BASIC authentication is executed.

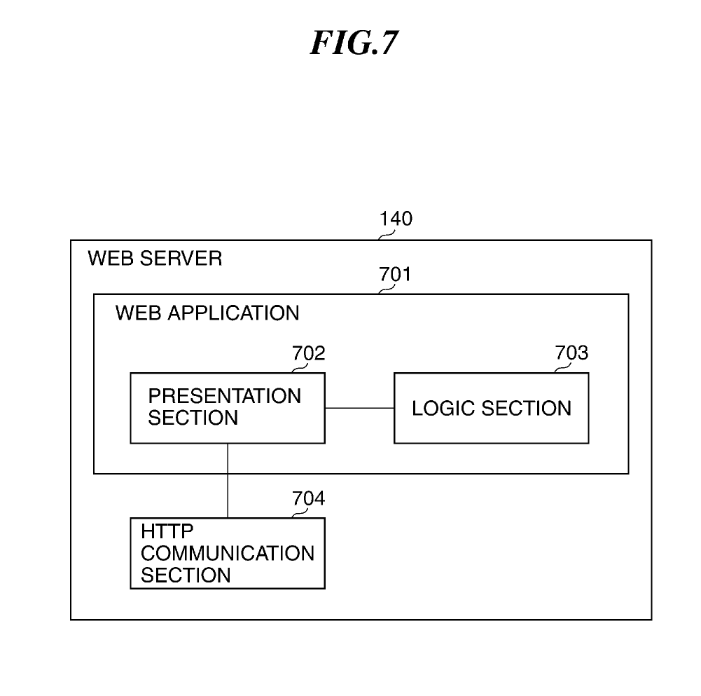

FIG. 7 is a schematic block diagram of the software configuration of the web server 140 appearing in FIG. 1. Software modules illustrated in FIG. 7 are stored in the HDD 304 of the web server 140 and are executed by the CPU 301.

Referring to FIG. 7, the web server 140 comprises a web application 701 and an HTTP communication section 704. The web application 701 includes a presentation section 702 and a logic section 703.

The presentation section 702 transmits an operation screen to be displayed as a response to an HTTP request from a client, via the HTTP communication section 704. Further, the presentation section 702 receives input information input by a user from the operation screen displayed on the client, via the HTTP communication section 704.

The logic section 703 processes input information passed from the presentation section 702. For example, the logic section 703 changes a screen to be displayed or generates job definition information necessary for execution of a device function of an MFP, according to an input from a user.

The HTTP communication section 704 is a module that controls the network interface 305 to perform communication using the HTTP protocol.

Next, a description will be given of the flow of a scan and transmission process executed in the image processing system in FIG. 1. The scan and transmission process is a series of processes for generating image data by reading an original image using the scanner section 112 of the MFP 110 and transmitting the generated image data to the web application 701 on the Internet 130.

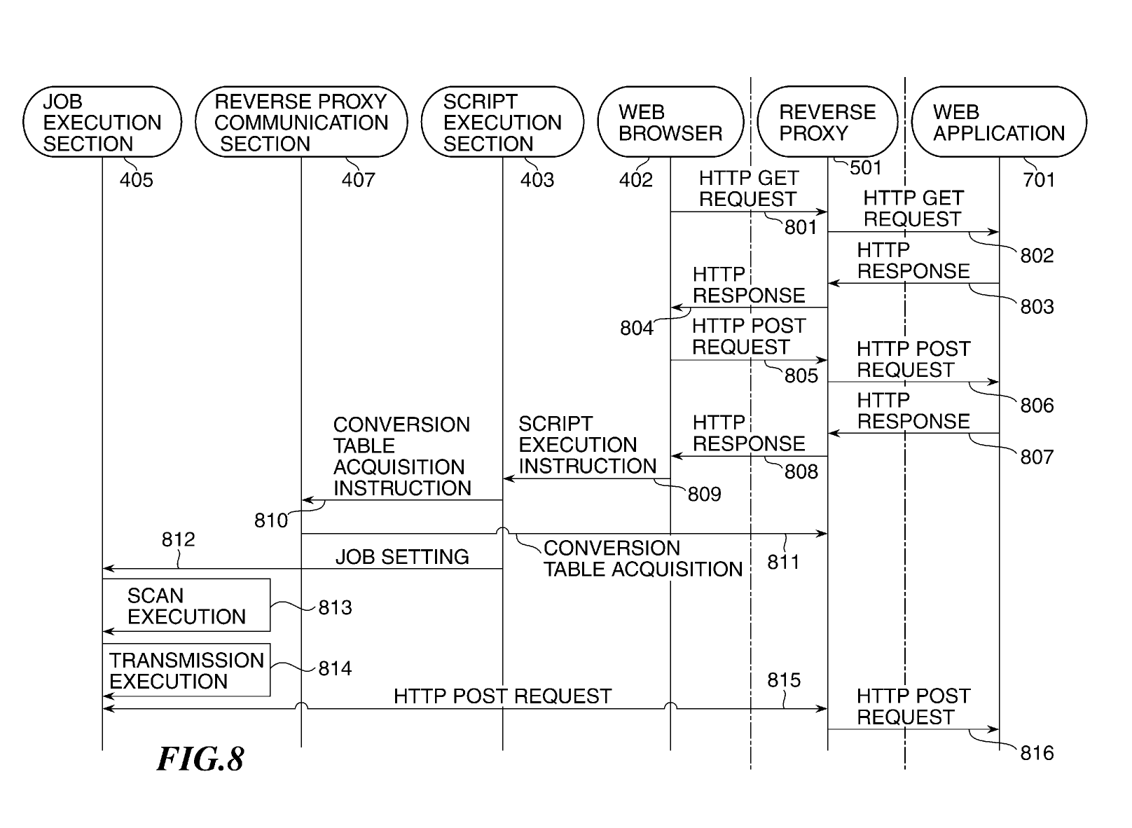

FIG. 8 is a sequence diagram of the scan and transmission process executed in the image processing system in FIG. 1.

First, a user starts the web browser 402 by pressing a hardware button (not shown) provided in the console section 111 of the MFP 110 for performing transmission of image data.

In order to acquire a configuration screen for execution of the process, the web browser 402 transmits a request for the configuration screen to the URL of the web application 701 on behalf of which the reverse proxy 501 acts. In the present embodiment, the URL of the configuration screen of the web application 701 is “http://www.serverA.xxx.com/scan/setting.cgi”. Further, in the present embodiment, it is assumed that a URL “http://<reverse proxy>/AppA/setting.cgi” which corresponds to the above-mentioned URL and indicates a content of the configuration screen which is executed by the reverse proxy 501 on behalf of the web application 701 is set in the MFP 110 in advance.

In a step 801, the web browser 402 makes a request using an HTTP CET command to the reverse proxy 501 indicated in the above-mentioned URL. Specifically, the web browser 402 passes HTML data to the HTTP communication section 401. In response to this, the HTTP communication section 401 communicates with the HTTP request-receiving section 502 of the reverse proxy server 120 using the HTTP protocol. This causes the request to be sent from the web browser 402 to the reverse proxy 501. At this time, in response to a connection request from the web browser 402, if a response that authentication is required is issued from the reverse proxy 501, the web browser 402 displays an authentication screen and receives authentication information from the user to make a request again.

In a step 802, the reverse proxy 501 sends the received HTTP request to the web application 701. Specifically, the HTTP request-receiving section 502 passes the received HTTP request to the URL rewriting section 503. The URL rewriting section 503 converts the URL of the HTTP request to the URL of a transmission destination according to the URL conversion table 508. In the present embodiment, the URL of the HTTP request is converted to the above-mentioned URL of the configuration screen. Further, in the present embodiment, BASIC authentication is required, and therefore a header for authentication is generated. Then, the HTTP request-transmitting section 504 transmits an HTTP request for requesting the content of the configuration screen from the rewritten URL, to the web application 701.

The execution of the above-described processing establishes SSO between the reverse proxy 501 and the web application 701, based on the authentication between the web browser 402 and the reverse proxy 501.

In a step 803, the presentation section 702 of the web application 701 generates HTML data of the configuration screen in response to the request received in the step 802, and sends the HTML data as a response to the reverse proxy 501.

In a step 804, the reverse proxy 501 transmits the HTML data received as the response to the web browser 402. Specifically, the reverse proxy 501 passes the HTML data received by the HTTP response-receiving section 505 to the HTML content-rewriting section 506. The HTML content-rewriting section 506 changes the link of the HTML data based on the URL conversion table 508. Then, the HTTP response-transmitting section 507 transmits the changed HTML data to the web browser 402 as the request source having issued the request in the step 801. The web browser 402 analyzes the received HTML data and displays the configuration screen on the console section 111.

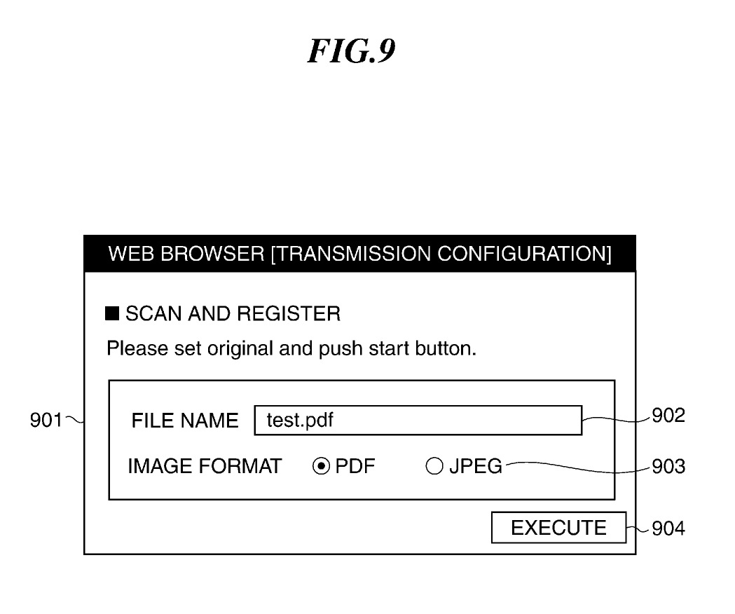

FIG. 9 is a view of an example of the configuration screen displayed by the web browser 402 in the step 804 in FIG. 8.

On a GUI panel 901, there are arranged a text box 902 for setting a file name and radio buttons 903 for selecting an image format. In the example shown in FIG. 9, image data is assigned a file name “test.pdf”, and a setting is made so as to generate the image data in the PDF format. A GUI button 904 is used to give an instruction for execution of the function. When the GUI button 904 is pressed by the user, the web browser 402 determines that an instruction for starting a scan operation has been issued.

In a step 805, the web browser 402 requests the reverse proxy 501 to execute the processing. More specifically, in response to the pressing of the GUI button 904 by the user, the web browser 402 notifies the reverse proxy 501 of parameters set in the text box 902 and the selected radio button 903. An HTTP POST command is used for the notification.

In a step 806, the reverse proxy 501 relays the HTTP request to the web application 701 as in the step 802.

In a step 807, the presentation section 702 of the web application 701 generates HTML data of the screen currently processed, in response to the HTTP request received in the step 806. Further, the logic section 703 generates script data for execution of the processing by the MFP 110 based on configuration information contained in the POST command received in the step 806. Then, the script data is transmitted to the reverse proxy 501 as a response to the HTTP request.

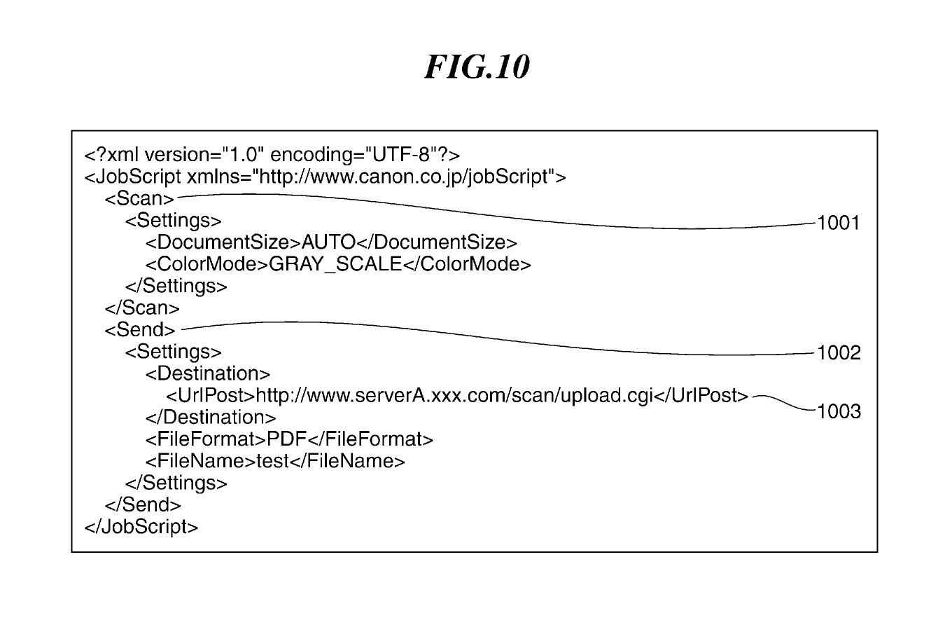

FIG. 10 is a view of an example of the script data generated by the logic section 703 and transmitted to the reverse proxy 501 in the step 807. In the present embodiment, it is assumed that the script data illustrated in FIG. 10 is used. Although in the present embodiment, script data is generated in XML as shown in FIG. 10, any format may be employed insofar as the script execution section 403 of the MFP 110 can execute the script.

A “Scan” tag 1001 describes configuration information for a scan process to be executed by the MFP 110. In the present embodiment, the “Scan” tag 1001 indicates that “Document Size” is set to “AUTO”, and “Color Mode” is set to “Gray Scale”.

A “Send” tag 1002 describes configuration information for a transmission process executed by the MFP 110. A tag 1003 describes that the script data is to be transmitted to a server “http://www.serverA.xxx.com/scan/upload.cgi” using the HTTP protocol. Further, it is also described that “File Format” is “PDF”, and “File Name” is “test”.

Referring again to FIG. 8, in a step 808, the reverse proxy 501 transmits the script data received in the step 807 to the web browser 402. The script data cannot be converted by the HTML content-rewriting section 506, and hence the received script data is immediately transmitted to the web browser 402.

In a step 809, the web browser 402 passes the script data received in the step 808 to the script execution section 403. Upon receipt of the script data, the script execution section 403 executes a job according to the details of the process described in the script data.

Next, a description will be given of a process in which the script execution section 403 receives script data and executes a job.

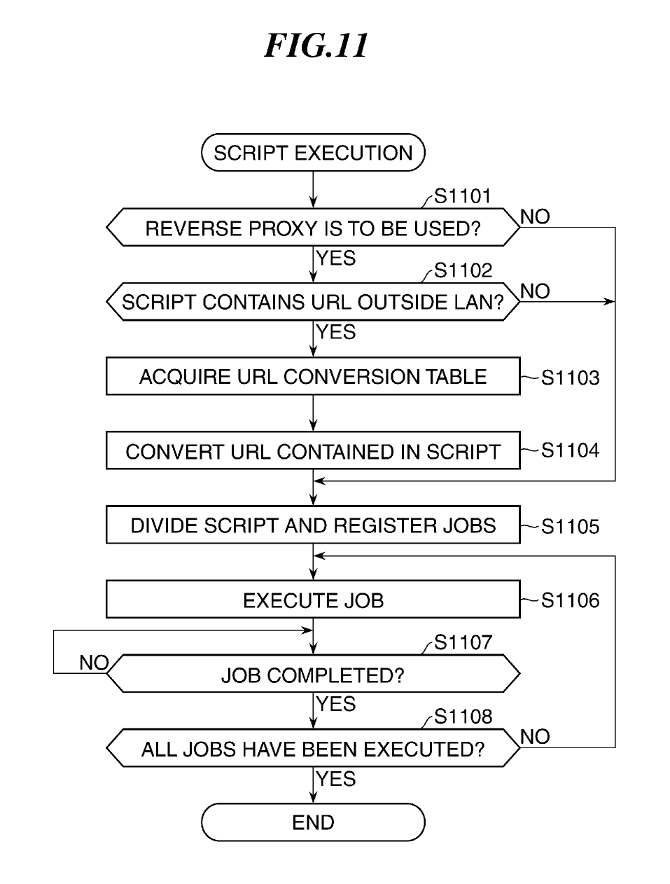

FIG. 11 is a flowchart of a script execution process executed by the script execution section 403 of the image processing apparatus according to the first embodiment.

In a step S1101, the script execution section 403 makes an inquiry to the communication setting management section 406 to determine whether a setting has been made to use the reverse proxy 501 has been set. If the setting of using the reverse proxy 501 has been made, the process proceeds to a step S1102, whereas if not, the process proceeds to a step S1105.

In the step S1102, the script execution section 403 analyzes the script data to determine whether or not the script contains a URL outside the LAN, i.e. whether or not the execution of the script involves communication via the reverse proxy 501 using the HTTP protocol. If the script contains a URL outside the LAN, i.e. if it is determined that the execution of the script involves communication via the reverse proxy 501 using the HTTP protocol, the process proceeds to a step S1103. Otherwise, the process proceeds to the step S1105. For example, if the script data contains a URL of the same network as the LAN 100, which means that HTTP communication is to be performed within the same network by execution of the script, it is determined that intervention of the reverse proxy 501 is unnecessary.

In the step S1103, the script execution section 403 instructs the reverse proxy communication section 407 to communicate with the reverse proxy 501 and acquire the URL conversion table 508. In doing this, the reverse proxy communication section 407 communicates with the setting changing section 509 of the reverse proxy 501 to acquire the information of the URL conversion table 508.

In a step S1104, the script execution section 403 rewrites the URL contained in the script data, based on the URL conversion table 508 acquired in the step S1103.

In the step S1105, the script execution section 403 divides the script data on a job basis and registers jobs in the job management section 404. In the case of the script data illustrated in FIG. 10, the script data is divided into two jobs, i.e. a scan job and a transmission job.

In a step S1106, the job management section 404 causes the job execution section 405 to execute a job.

In a step S1107, the job management section 404 monitors the job execution section 405 and determines whether or not the job has been executed. If the job has been executed, the process proceeds to a step S1108.

In the step S1108, the job management section 404 determines whether or not all the jobs have been executed. If not all the jobs have been executed, the process returns to the step S1106, wherein a next job is executed. On the other hand, if all the jobs have been executed, the present process is terminated.

Next, a description will be given of the sequence of the scan job and the transmission job (corresponding to steps 810 to 815 in FIG. 8) executed by the MFP 110 when the above-described script is executed by the script execution section 403.

Referring again to FIG. 8, in the step 810, in response to the script execution instruction issued in the step 809, the step S1103 in FIG. 11 is executed based on the determination in the step S1102, so that an instruction for acquisition of the URL conversion table 508 is issued from the script execution section 403 to the reverse proxy communication section 407.

In the step 811, the step S1103 in FIG. 11 is executed, and the reverse proxy communication section 407 communicates with the setting changing section 509 of the reverse proxy 501 to acquire the information of the URL conversion table 508. Then, the step S1104 is executed, whereby the tag 1103 contained in the script data is rewritten into the following URL:

“http://<reverse proxy>/AppA/upload.cgi”.

After the rewriting, the instruction originally to be transmitted to the web application 701 in the transmission job is changed into an instruction to be transmitted to the associated reverse proxy 501.

In the step 812, the step S1105 in FIG. 11 is executed. In the present embodiment, the two jobs, i.e. the scan job and the transmission job are registered in the job execution section 405.

In the step 813, the scan job registered in the step 812 is executed. Specifically, the job execution section 405 drivingly controls the scanner section 112 via the scanner interface 207 and stores a read image in the HDD 204.

In the step 814, the transmission job registered in the step 812 is executed. Specifically, the job execution section 405 reads out the image read in the step 813, from the HDD 204, and the image processing section 208 performs processing on the image, whereby a file in a predetermined file format is generated.

The step 815 is a continuation of the transmission job in the step 814. Specifically, the job execution section 405 transmits the file using the HTTP protocol to the URL of the reverse proxy 501 changed by the above-described URL rewriting. In the present embodiment, it is assumed that the image file is transmitted using an HTTP POST command. When authentication is required between the job execution section 405 and the reverse proxy 501 at this time, the authentication is performed by acquiring the authentication information from the communication setting management section 406.

In a step 816, the reverse proxy 501 transmits the received HTTP request to the web application 701. Specifically, the same processing as in the step 802 or 806 is executed.

The above is the sequence of scan and transmission using the HTTP protocol, which is executed according to an instruction from the web application 701.

According to the present embodiment, even though the reverse proxy 501 does not rewrite a job execution instruction for a job including HTTP communication with the MFP 110, the software module of the MFP 110 communicates with the reverse proxy 501. This makes the MFP 110 compatible with the reverse proxy-type SSO system. As a consequence, an image processing apparatus having a web browser can appropriately operate in the reverse proxy-type SSO system according to an instruction from the web server.

Although in the present embodiment, the reverse proxy communication section 407 communicates with the reverse proxy 501 according to the script execution instruction, the reverse proxy communication section 407 may hold a cache of the URL conversion table 508 so as to eliminate the need for acquiring the URL conversion table 508 each time. Further, insofar as timing for caching the URL conversion table 508 is concerned, it is also possible to employ a method in which the URL conversion table 508 is updated by receiving a notification from the reverse proxy 501 not in timing for script execution, but e.g. in timing in which a setting of the reverse proxy 501 is changed.

Next, a description will be given of a second embodiment of the present invention. In the above-described first embodiment, the description is given of an example in which in a reverse proxy-type SSO environment, the MFP 110 transmits a scanned image according to an instruction from a web server. In the second embodiment, a script executed by the MFP 110 contains a job of WebDAV transmission. Further, an authentication method for use in WebDAV transmission is specified in an instruction from a web application. Note that the MFP as an image processing apparatus according to the second embodiment has the same hardware configuration and software configuration as those of the MFP as the image processing apparatus according to the first embodiment. Therefore, the same components and elements as those of the first embodiment are denoted by the same reference numerals, and description thereof is omitted. In the following, a description will be given only of different points from the first embodiment.

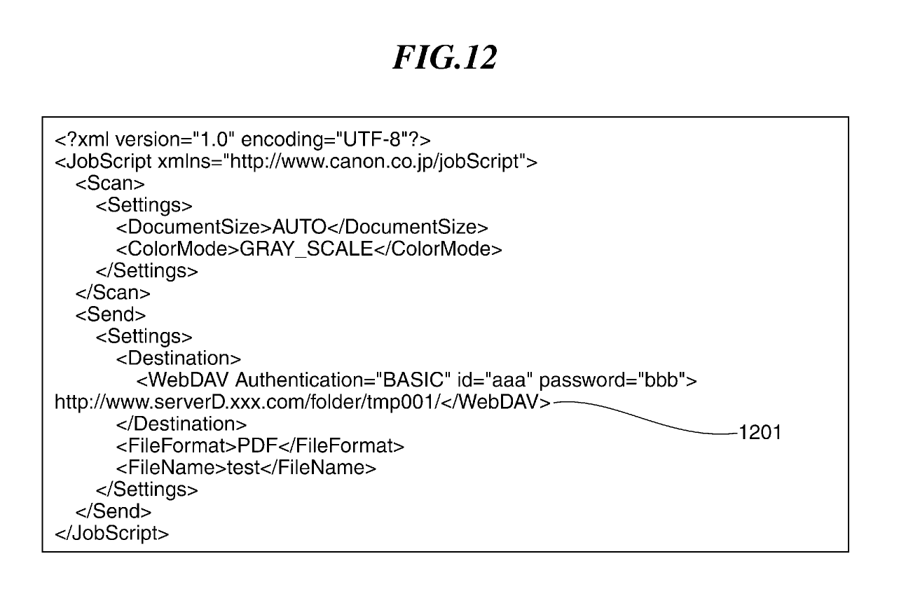

FIG. 12 is a view of an example of script data passed from the web application 701 to the web browser 402 in the second embodiment.

The script data illustrated in FIG. 12 is distinguished from the script data in FIG. 10 in the first embodiment by a tag 1201. The tag 1201 describes that transmission is to be performed using the WebDAV protocol. Further, the tag 1201 describes that the authentication method (Authentication) is BASIC authentication, the ID (id) is “aaa”, and the password is “bbb” and that a file is generated with the following URL:

“http://<reverse proxy>/AppA/upload.cgi”.

In the script data illustrated in FIG. 12, authentication information for use in accessing a WebDAV server is specified, and therefore it is required to use this authentication information for communication between the reverse proxy 501 and the web application 701.

Next, a description will be given of a process in which the script execution section 403 receives script data and executes jobs.

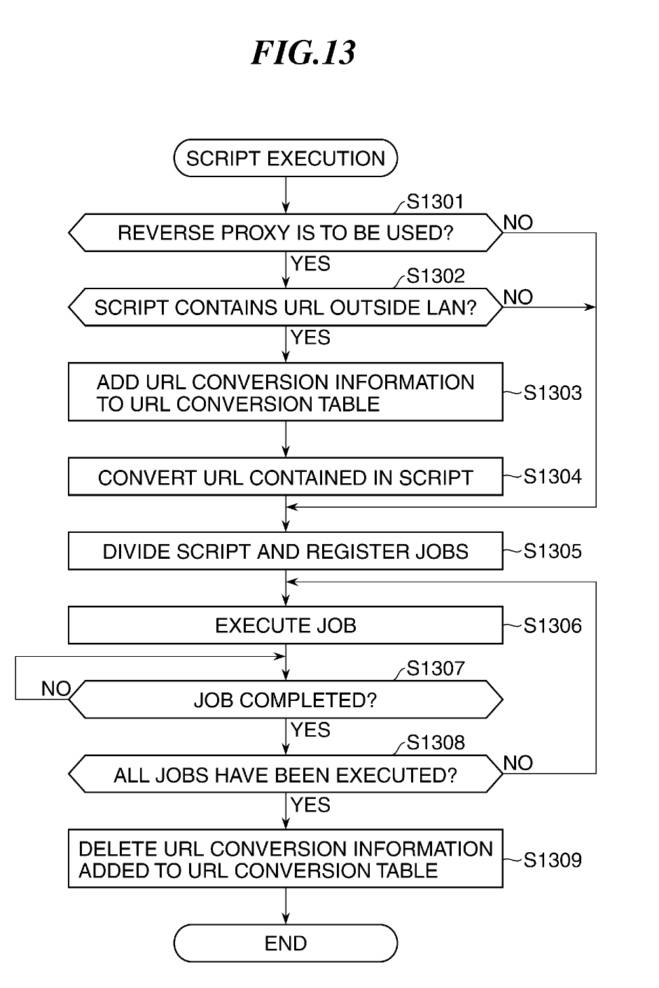

FIG. 13 is a flowchart of a script execution process executed by the script execution section 403 of the image processing apparatus according to the second embodiment.

In a step S1301, the script execution section 403 makes an inquiry to the communication setting management section 406 to determine whether or not a setting has been made to use the reverse proxy 501 has been set. If the setting of using the reverse proxy 501 has been made, the process proceeds to a step S1302, whereas if not, the process proceeds to a step S1305.

In the step S1302, the script execution section 403 analyzes the script data to determine whether or not the script contains a URL outside the LAN, i.e. whether or not the execution of the script involves communication via the reverse proxy 501 using the HTTP protocol. If the script contains a URL outside the LAN, i.e. if it is determined that the execution of the script involves communication via the reverse proxy 501 using the HTTP protocol, the process proceeds to a step S1303. Otherwise, the process proceeds to the step S1305.

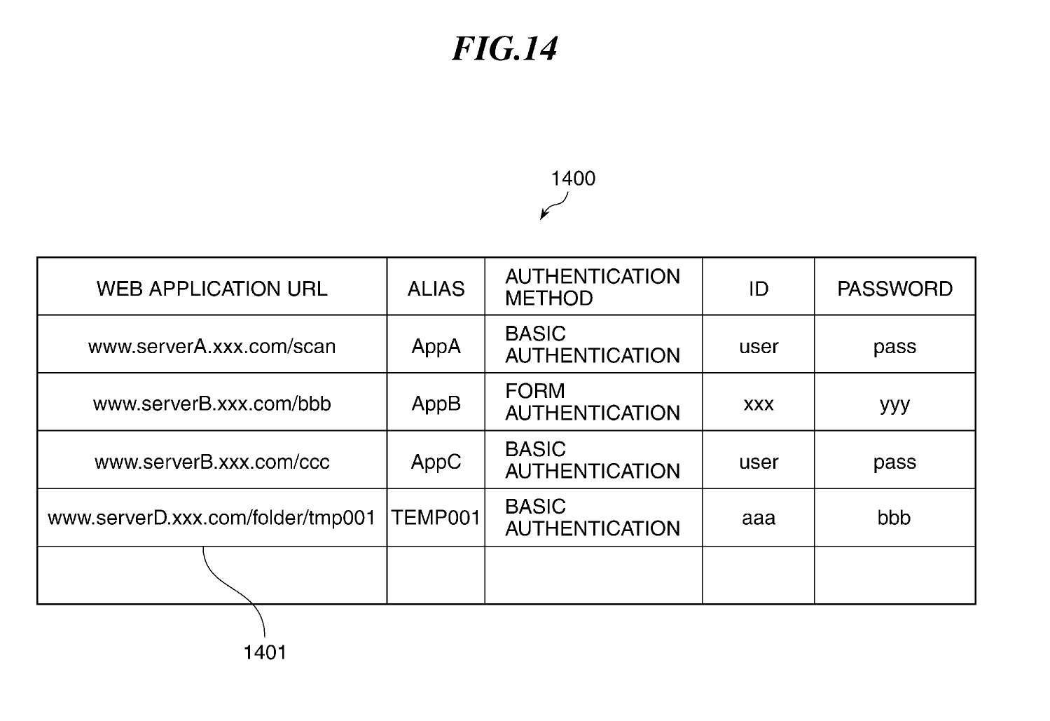

In the step S1303, the script execution section 403 instructs the reverse proxy communication section 407 to communicate with the reverse proxy 501 and configure the URL conversion table 508. In this case, the reverse proxy communication section 407 communicates with the setting changing section 509 of the reverse proxy 501 and add a setting of URL conversion information contained in the script data to the URL conversion table 508. FIG. 14 shows a URL conversion table 1400 obtained after addition of the setting of the URL conversion information in the step S1303.

In the URL conversion table 1400, the URL and the authentication information associated with the tag 1201 of the script data are additionally set as the URL conversion information in a column 1401.

Referring again to FIG. 13, in a step S1304, the script execution section 403 rewrites the URL contained in the script data, based on the URL conversion information additionally set in the URL conversion table 1400 in the step S1303. In the present embodiment, the URL section of the tag 1201 is changed to the following URL:

“http://<reverse proxy>/TEMP001/”.

In the step S1305, the script execution section 403 divides the script data on a job basis and registers jobs in the job management section 404. In the case of the script data illustrated in FIG. 12, the script data is divided into two jobs, i.e. a scan job and a transmission job.

In a step S1306, the job management section 404 causes the job execution section 405 to execute a job. Since the transmission destination of the transmission job has been changed to the URL of the reverse proxy 501 in the step S1305, the destination of transmission to be performed by the job execution section 405 using the WebDAV protocol is the reverse proxy 501. Upon receipt of communication from the job execution section 405, the reverse proxy 501 performs URL conversion with reference to information in the column 1401 of the URL conversion table 1400. Accordingly, the reverse proxy 501 performs communication with the WebDAV server indicated by the URL in the tag 1201 of the original script data, using the authentication information described in the script data.

In a step S1307, the job management section 404 monitors the job execution section 405 and determines whether or not the job has been executed. If the job has been executed, the process proceeds to a step S1308.

In the step S1308, the job management section 404 determines whether or not all the jobs described in the script data have been executed. If not all the jobs have been executed, the process returns to the step S1306, wherein a next job is executed. On the other hand, if all the jobs have been executed, the present process proceeds to a step S1309.

In the step S1309, the script execution section 403 instructs the reverse proxy communication section 407 to delete from the column 1401 the URL conversion information additionally set in the URL conversion table 1400 in the step S1303. Note that when URL conversion information was not additionally set in the URL conversion table 1400 in the step S1303, data deletion is not performed.

As described above, the software module of the MFP 110 communicates with the reverse proxy 501, whereby it is possible to control authentication in communication between the reverse proxy 501 and the web application 701. This enables the MFP 110 to execute a transmission job using an authentication method contained in an instruction from the web application 701.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2011-141718 filed Jun. 27, 2011, which is hereby incorporated by reference herein in its entirety.

What is claimed is:

1. An image processing apparatus that communicates with a server via a relay apparatus, comprising:
an acquisition unit configured to be operable when a script containing a URL is received from the server via the relay apparatus, to acquire conversion information for converting the URL contained in the script to another URL, from the relay apparatus; and
a rewriting unit configured to rewrite the URL contained in the script received from the server, based on the conversion information.

2. The image processing apparatus according to claim 1, wherein when the URL contained in the script is an address of the server, said rewriting unit rewrites the URL.

3. The image processing apparatus according to claim 1, wherein when the URL contained in the script is an address of an apparatus belonging to a network other than a network to which the image processing apparatus belongs, said rewriting unit rewrites the URL.

4. The image processing apparatus according to claim 1, wherein said rewriting unit rewrites a host name of the URL contained in the script into a host name of the relay apparatus.

5. The image processing apparatus according to claim 4, further comprising a reading unit configured to optically read an original according to the received script.

6. The image processing apparatus according to claim 5, further comprising a transmission unit configured to transmit image data of the original read by said reading unit to the URL rewritten by said rewriting unit.

7. The image processing apparatus according to claim 1, wherein the relay apparatus is a reverse proxy server.

8. The image processing apparatus according to claim 1, wherein the script is contained in a body section of an HTTP response message.

9. The image processing apparatus according to claim 8, wherein the script is described in XML.

10. The image processing apparatus according to claim 1, wherein the image processing apparatus receives an HTTP response message containing the script as a response to transmission of an HTTP request message.

11. A method of controlling an image processing apparatus that communicates with a server via a relay apparatus, comprising:
receiving a script containing a URL from the server via the relay apparatus;
acquiring conversion information for converting the URL contained in the received script to another URL, from the relay apparatus; and
rewriting the URL contained in the script received from the server, based on the acquired conversion information.

12. A non-transitory computer-readable storage medium storing a computer-executable program for causing a computer to execute a method of controlling an image processing apparatus that communicates with a server via a relay apparatus,
wherein the method comprises:
receiving a script containing a URL from the server via the relay apparatus;
acquiring conversion information for converting the URL contained in the received script to another URL, from the relay apparatus; and
rewriting the URL contained in the script received from the server, based on the acquired conversion information.
